(19) United States
(12) Patent Application Publication
(10) Pub. No.: US 2017/0094989 A1
(43) Pub. Date: Apr. 6, 2017

(54) TABLET OF SOLUBLE COFFEE AND METHOD FOR PREPARING A BEVERAGE

(71) Applicant: Hausbrandt Trieste 1892 SPA, Nervesa della Battaglia (TV) (IT)

(72) Inventor: Martino Zanetti, Treviso (IT)

(21) Appl. No.: 15/124,731

(22) PCT Filed: Mar. 10, 2015
(86) PCT No.: PCT/IB2015/051734

§ 371 Date: Sep. 9, 2016

(30) Foreign Application Priority Data
Mar. 10, 2014 (IT) TV2014000037

(51) Int. Cl. A23F 5/38

(52) U.S. Cl. CPC A23F 5/385

(57) ABSTRACT

A tablet (12) of soluble coffee comprises a predetermined amount of soluble coffee powder, suitable for producing a coffee-based beverage when immersed in water or other liquid substance. The tablet is characterized in that it comprises at least one hole (14) for increasing the wettable surface area of the tablet (12). Also described is a method for preparing a beverage, associated with the tablet.

The present invention relates to a tablet consisting of a soluble substance, for example soluble coffee, and to method for preparing a beverage associated therewith.

As will become clear from the present description below the principles of the present invention may also be applied to other types of soluble substances, such as tea, barley, etc. In the present description reference will be therefore made to coffee for the sake of easier illustration.

Soluble coffee, also called instant coffee, consists essentially of a dried preparation derived from an infusion, without the aqueous part. The beverage is then reconstituted by mixing the soluble coffee with hot or cold water depending on the beverage which is to be prepared. Soluble coffee may be used for preparing coffee, but may also be mixed with milk for preparing a milk coffee.

One of the main advantages of this type of coffee is that the corresponding beverage may be prepared without using a coffee maker or other infusion instruments since only hot water is required. Soluble coffee is therefore advantageously used in all those situations in which a conventional coffee maker cannot be used, for example during a trip, while camping, etc., or when one has little time available, but nevertheless wishes to drink a coffee.

In the present state of the art many types of soluble powder coffee packaged in jars, bags or single-dose wrappings are known.

Also known in the present state of the art is a type of soluble coffee in the form of tablets of compacted powder. Soluble coffee powder is currently compacted using methods which are known per se and therefore will not be described in detail here. For example, compaction may be performed by means of a rotary compactor, with the addition of sweeteners and/or thickening agents which are mixed with the coffee.

The tablets may be in the form of a cube, parallelepiped or the like.

This solution is advantageous compared to the solution using powder coffee because it allows the user to be provided with portions which have a well-defined amount of coffee powder designed to ensure an optimum preparation of the beverage, in a format which is more practical than powder or granules.

Furthermore there is no need to use a teaspoon in order to remove the coffee powder from the jar or bag, with the risk of accidental spillage of the powder.

However, the soluble coffee tablets according to the prior art, although widely used, are not without drawbacks.

In fact, comparing the time required to mix soluble coffee tablets with the time needed to mix uncompacted coffee powder, it can be noted that the time needed to mix uncompacted powder is much shorter than the former.

In fact, at least during the first instants when the soluble coffee tablet is immersed in the water (or other liquid depending on the type of beverage which is to be prepared), the coffee powder part which is moistened by the water is only that part which is situated on the outer surface of the tablet. Then, as the powder forming the outer surface gradually dissolves, the water also reaches the powder which is situated inside the tablet.

Therefore, compared to uncompacted soluble coffee powder which is totally covered with water immediately after being placed in the dosed amount inside the receptacle for preparing the beverage, the tablet requires a longer time.

Moreover, the coffee tablets according to the prior art are not packaged in such a way as to ensure that their organoleptic properties remain unchanged for the longest possible time after packaging. In fact, the jars or bags always contain a large amount of tablets so that, once opened, the tablets in the jar or bag are exposed to air, even on several occasions, and therefore their organoleptic properties could be negatively affected.

The object of the present invention is therefore to solve at least partially the drawbacks of the prior art.

A first task is that of providing a tablet consisting of a powder of soluble substance which can be easily mixed with the water and which therefore allows the preparation of the beverage in a short amount of time.

A second task of the present invention is to provide a method for preparing a beverage which allows the preparation of the coffee in a short amount of time.

A further task is that of providing a packaging for soluble coffee tablets which allows the organoleptic characteristics of the coffee tablet to remain unchanged for the longest possible amount of time.

The idea which has occurred therefore is that of providing a tablet of soluble coffee with a solid form, i.e. for example a disc-shaped or cube-shaped form, which is provided with at least one hole. Furthermore the idea which has occurred is that of providing a tablet which is packaged individually in a suitable wrapping so as to prevent the passage of gas between the outside and inside of the wrapping and between the inside and outside of the wrapping.

Advantageously, the tablet may be provided inside the wrapping in a controlled atmosphere, for example nitrogen.

A method has also been developed for preparing a beverage which allows a beverage to be prepared in a short amount of time, using a soluble coffee tablet according to the present invention.

The characteristic features and advantages of a soluble coffee tablet made by applying the principles of the present invention will emerge more clearly from the description hereinbelow, of preferred examples of embodiment provided by way of a non-limiting example with reference to the accompanying drawings, in which:

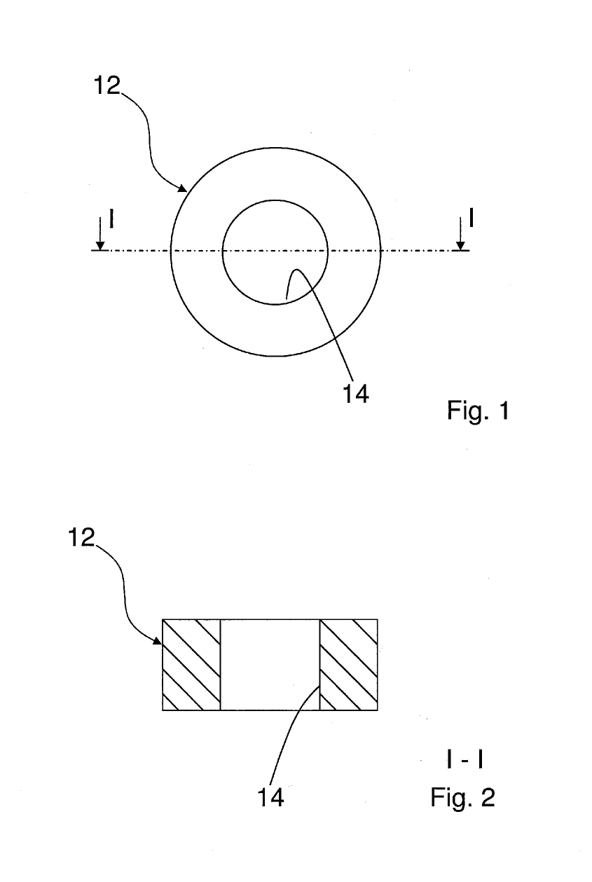

FIG. 1 shows a schematic top plan view of a soluble coffee tablet according to a possible embodiment of the present invention;

FIG. 2 shows a schematic cross-sectional view of the soluble coffee tablet shown in FIG. 1;

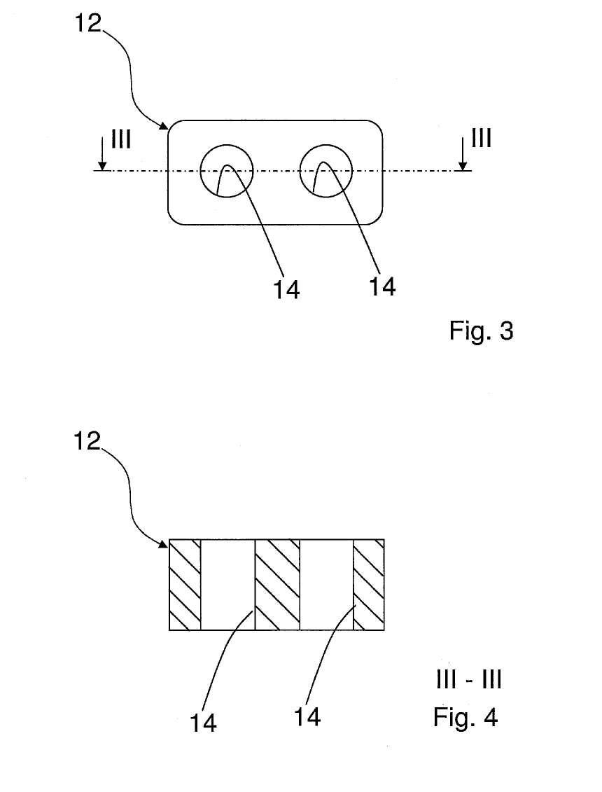

FIG. 3 shows a schematic top plan view of a soluble coffee tablet according to an alternative embodiment of the present invention; and

FIG. 4 shows a schematic cross-sectional view of the soluble coffee tablet shown in FIG. 3.

The tablet 12 of soluble coffee according to the present invention comprises a predetermined quantity of soluble coffee. According to a possible embodiment of the present invention the quantity of soluble coffee by weight may be between 3 and 10 grammes.

As mentioned above, the soluble coffee powder is currently compacted using methods which are known per se and will therefore not be further described here.

The tablet 12 of compacted soluble coffee powder may have a cube-like, parallelepiped or disc-like form. It must however be considered that the soluble coffee tablet according to the present invention may have any solid form.

Advantageously, in the case of a disc-shaped soluble coffee tablet, the diameter may be between 33 and 36 mm and the thickness may be between 9 and 13 mm.

According to a possible embodiment of the present invention the at least one hole 14 is a through-hole, as can be clearly seen in the accompanying figures.

In accordance with alternative embodiments of the present invention (not shown), the at least one hole 14 could also not be a through-hole. In this case the at least one hole is essentially a depression on the outer surface of the tablet.

Advantageously the hole may be circular or elliptical. In the case of a circular hole, the size of its diameter may be greater than 9 mm, and preferably between 9 and 12 mm.

In accordance with possible embodiments of the present invention, the holes 14 may consist of a plurality of holes.

FIGS. 3 and 4 show a tablet of soluble coffee powder with two holes 14.

Advantageously, the tablet 12 of soluble coffee may be packaged individually inside a wrapping which prevents the passage of fluid from the outside to the inside of the wrapping and from the inside to the outside of the packaging. It has in fact been noted that increasing the wettability of the tablet increases also the area thereof which is exposed to air. For this reason it has proved to be particularly advantageous to package the soluble coffee tablets individually inside a protective wrapping.

In accordance with a possible embodiment of the present invention, the protective wrapping may consist of packaging aluminium, plastic or a composite material such as triplex, aluminium polypropylene or in any case other materials suitable for this purpose.

The advantages compared to the tablets of the prior art are therefore now clear.

Firstly, the holes present in the coffee tablet increase the surface area which can be wetted by the liquid inside which the tablet is immersed, increasing the mixing speed and therefore reducing the time needed for preparation of the beverage.

Furthermore, a packaging for soluble coffee tablets is provided such that the organoleptic characteristics of the coffee tablet remain unchanged for the longest possible amount of time.

Moreover, the method for producing a beverage is very fast compared to the prior art. It is sufficient to prepare a receptacle with hot or cold water, depending on the type of beverage to be prepared, and immerse the tablet of soluble coffee described above.

The description makes reference to tablets of soluble coffee, but the innovative principles of the present invention may be applied also to other types of soluble beverages such as infusions, soups, etc.

Moreover, reference has been made to water as the liquid in which the tablet may be dissolved, but the principles of the present invention may also be applied to other liquids such as milk, for the preparation of a milk coffee.

Depending on the quantity of water which is provided in the receptacle, it is possible to obtain a coffee of the desired intensity.

The person skilled in the art, in order to satisfy specific requirements, may make modifications to the embodiments described above and/or replace the parts described with equivalent parts, without thereby departing from the scope of the accompanying claims.

1. Tablet (12) of soluble coffee comprising a predetermined quantity of soluble coffee powder, suitable for producing a coffee-based beverage when immersed in water or other liquid substance,
characterized in that it comprises at least one hole (14) for increasing the wettable surface area of the tablet (12).

2. Tablet (12) of soluble coffee according to the preceding claim, characterized in that said at least one hole is a through-hole.

3. Tablet (12) of soluble coffee according to any one of the preceding claims, characterized in that it has a disc-shaped form.

4. Tablet (12) of soluble coffee according to either one of claims 1 and 2, characterized in that it has a parallelepiped form.

5. Tablet (12) of soluble coffee according to any one of the preceding claims, characterized in that said at least one hole (14) has a circular cross-section.

6. Tablet (12) of soluble coffee according to any one of the preceding claims, characterized in that it is provided with two holes (14).

7. Tablet (12) according to any one of the claims 1-5, characterized in that it is provided with a plurality of holes (14).

8. Tablet (12) of soluble coffee according to any one of claims 1 to 7, characterized in that it is packaged individually inside a protective wrapping which prevents the passage of gases from the outside to the inside of the wrapping and from the inside to the outside of the wrapping.

9. Tablet (12) of soluble coffee according to any one of the preceding claims, characterized in that said at least one hole (14) has dimensions greater than 9 mm.

10. Tablet (12) of soluble coffee according to the preceding claim, characterized in that said at least one hole (14) has dimensions of between 9 and 12 mm.

11. Method for preparing a coffee-based beverage, comprising a first step during which a dosed amount of water is provided inside a receptacle and a second step during which a tablet (12) of soluble coffee according to any one of the preceding claims is immersed in the water present inside said receptacle.
